(19) United States
(12) Patent Application Publication
(10) Pub. No.: US 2023/0347578 A1
(43) Pub. Date: Nov. 2, 2023

(54) METHOD OF REALIZATION OF AN ITEM FOR AERONAUTICAL APPLICATION WITH HYBRID COMPOSITE MATERIALS BY MEANS OF ADDITIVE TECHNOLOGY

(71) Applicant: LEONARDO S.P.A., ROMA (IT)

(72) Inventors: Francesco Acerra, Torino (IT); Fabio De Pompeis, Torino (IT); Generoso Iannuzzo, Torino (IT)

(21) Appl. No.: 17/923,136

(22) PCT Filed: May 6, 2021
(86) PCT No.: PCT/IB2021/053839

§ 371 Date: Nov. 3, 2022

(30) Foreign Application Priority Data
May 6, 2020 (IT) 102020000010120

(51) Int. Cl. B29C 64/118; B33Y 10/00; B33Y 50/02; B29C 64/393

(52) U.S. Cl. CPC B29C 64/118; B29C 64/393; B33Y 10/00; B33Y 50/02; B29K 2105/12

(57) ABSTRACT

A method of realization of an aeronautical item with hybrid composite materials by means of additive technology comprising the steps of: design of the product by means of a three-dimensional mathematical model which defines, in a reference system, the shape and dimensions and includes the information associated with the areas of the item that must be reinforced according to the level of stress; deposition, by means of additive technology, of a matrix in polymeric material and of reinforcing fibers according to the mathematical model; deposition of one or more continuous fibers made of different materials along articulated paths in correspondence with the areas that must be reinforced according to the level of stress (continuous fibers oriented along paths defined by the directions of the loads or in any case in the directions provided in the design phase).

### CROSS-REFERENCE TO RELATED APPLICATIONS

This patent application is a U.S. National Phase Application under 35 U.S.C. §371 of International Patent Application No. PCT/IB2021/053839, filed on May 6, 2021, which claims priority from Italian patent application no. 102020000010120, filed on May 6, 2020, all of which are incorporated by reference, as if expressly set forth in their respective entireties herein.

### TECHNICAL FIELD

The present invention relates to a method of realization of an aeronautical item with hybrid composite materials by means of additive technology.

### BACKGROUND ART

As is known, additive technology (Additive Manufacturing) is a process of depositing and joining materials to realize objects from computerized 3D models.

Additive technology uses data processed by CAD (Computer Aided Design) software or from scanners and describing an object to be made to direct a deposition device to deposit material, layer-by-layer, thereby creating precise geometric shapes. As the name suggests, additive technology adds material to create an object. Conversely, when creating an object by conventional means it is often necessary to remove the excess material by milling, machining, carving, shaping or other means.

Additive technology is sometimes described as “three-dimensional printing,” which is actually a subcategory of additive technology.

### SUMMARY OF THE INVENTION

It is an object of the present invention to develop a method for manufacturing an item made of hybrid composite material by additive technology, which is particularly suitable for aeronautical applications.

“Hybrid composite material” is intended to mean a thermoplastic polymer reinforced with chopped fibers (generally made of carbon) and continuous fibers of different types (carbon, glass, aramid, etc.).

Two patents relating to Additive Manufacturing technology already exist in the aeronautical field. However, the present proposal differs therefrom in terms of method, materials, and applications.

A brief description of the above-mentioned patents is given below:
1. Boeing’s patent EP3103568B1 describes a method of additive manufacturing of an item for aeronautical application, which provides for the use of hydrogenated titanium in the formation of an object by additive manufacturing, with the object
   having a first microstructure. The method comprises heat treatment of the hydrogenated titanium and, once the shape of the object is completed, dehydrogenation thereof. The dehydrogenated object takes on a second microstructure different from the first.
1. Patent application CN105252003A describes an additive manufacturing method for aircraft spar components.
2. US 2017/259502 describes an additive manufacturing apparatus having a three-dimensional movement system.

The method of realization of an aeronautical item with hybrid composite materials by means of additive technology as claimed in claim 1.

### BRIEF DESCRIPTION OF THE DRAWINGS

The invention will be described in the attached drawings which represent non-limiting examples.

FIGS. 1 and 2 schematically show a device which implements the method of the present invention.

FIG. 3 is a schematic top view of a layer of material deposited by the method of the present invention.

FIG. 4 schematically shows the heterogeneity of the various layers that can be obtained by means of the method of the present invention, using materials consisting of:
resin alone,
resin reinforced with chopped fiber,
resin reinforced with continuous fibers,
resin reinforced with chopped fiber and further reinforced with continuous fibers.

The continuous fibers can be of different types, laid in different areas and with different orientations within the same layer.

FIGS. 5 and 6 show, by way of example, objects made according to the method of the present invention.

### DESCRIPTION OF THE EMBODIMENT

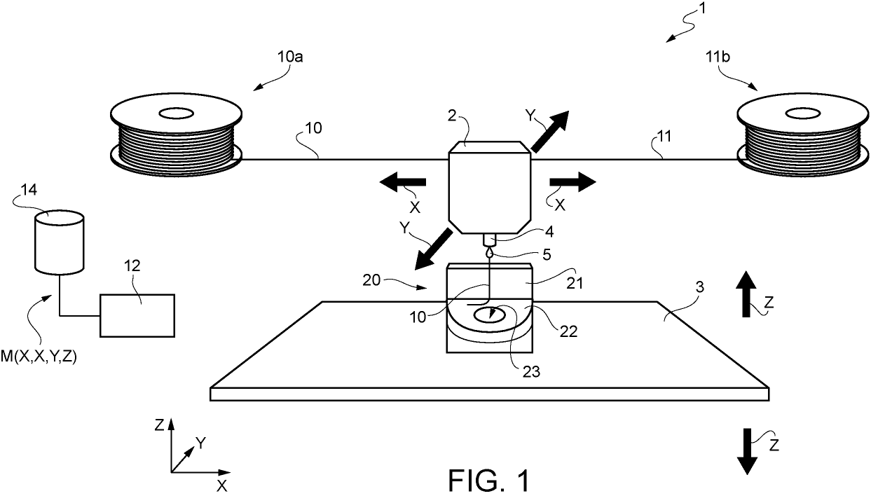

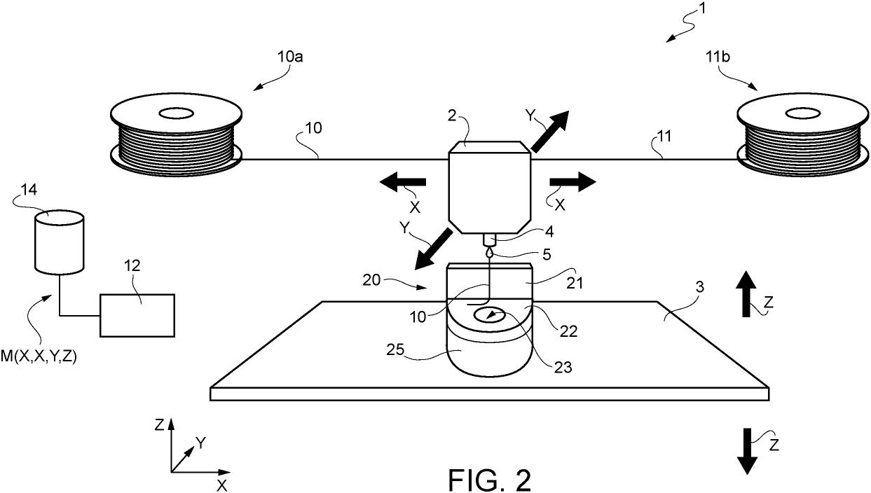

With reference to FIGS. 1 and 2, the reference numeral 1 designates a deposition device for manufacturing an item with hybrid composite materials for aeronautical application by means of additive technology.

The deposition device 1, shown schematically, comprises a movable deposition head 2, which can move in opposite directions along perpendicular directions X and Y in a two-dimensional space XY, under the thrust of actuators (not shown) carried by a known support structure (not shown for simplicity).

The deposition device 1 is configured to produce an object on a support surface 3, which can move in opposite directions along a direction Z orthogonal to the directions X and Y.

The deposition head 2 is provided with an extruder 4 suitable for extruding a mixture 5 of polymeric material and chopped reinforcing fibers. This mixture 5 is extruded as a plastic material and is subsequently cured by cooling and crosslinking.

Among the thermoplastic resins that can be used, we point out polyetherimide (also referred to as PEI) which, as is known, is a high-performance amorphous technopolymer introduced in 1982. Polyetherimide is easy to extrude and model. It has excellent chemical resistance and high stability and is therefore suitable for technical applications.

Other examples of polymeric materials that can be used are: PPS (polyphenylene sulfide), PEEK (Polyether ether ketone), PEK (Polyetherketone), PAEK (polyaryletherketone), etc.

The continuous reinforcing fibers can be of the synthetic and natural type.

The most widely used of the synthetic reinforcing fibers are carbon, glass and aramid fibers.

Natural reinforcing fibers include, for example, hemp and flax fibers.

Chopped fibers are generally of the synthetic type, specifically made of carbon.

The deposition head 2 is also suitable to deposit at least one continuous fiber 10 (made of carbon, glass, aramid), generally soaked in the same polymer used for the matrix. Typically, the fiber 10 is delivered by the same extruder 4, just like the resin and chopped fiber mixture 5.

The deposition head 2 can also deposit a further continuous fiber 11 made of a material different from that of the fiber 10, also delivered by the extruder 4.

For example, the fiber 10 may be a carbon fiber and the fiber 11 may be a glass fiber.

The fibers 10 and 11 are housed on the supports 10-a and 11-a, which are schematized as spools in FIGS. 1 and 2.

The movement of the head 2 and the support surface 3 is controlled by an electronic control unit 12, which also controls the flow of the delivered mixture 5 and the delivery of the continuous fibers 10 and 11.

The electronic unit 12 communicates with a database 14 in which a mathematical model (M(x,y,x)) of an item 20 to be created is stored. The mathematical model (M(x,y,x)) defines, in a reference system, the shape and dimensions of the item and includes the information associated with the areas of the item that must be reinforced according to the level of stress.

The item 20, shown by way of example in FIGS. 1 and 2, is a ring fitting consisting of a rectangular base wall 21 and a ring portion 22 defining a through hole 23. The ring portion 22 must be structurally reinforced around the through hole 23.

It is clear, however, that any item can be made, for example, a wing profile, an aircraft control surface, etc.

According to the present method, the following steps are carried out:
providing the electronic control unit 12 with the mathematical model (M(x,y,x)) of the item;
depositing, by means of additive technology, the mixture 5 of polymeric material and chopped reinforcing fibers according to the mathematical model, thereby forming the first layer of the item;
depositing on the first layer one or more continuous fibers 10 and/or 11 which extend in correspondence with the areas that must be reinforced according to the level of stress.

Typically, as provided by the additive technology, a plurality of superimposed layers can be deposited, in which the continuous fibers 10 and/or 11 can be arranged in one or more layers. In this way, the item 20 is made with a layered structure, in which the continuous fibers 10 and/or 11 are incorporated between the adjacent layers, generally consisting of resin and chopped fiber.

Thus, the outer layers (the skin) of the layered structure are devoid of the continuous fibers, whereas the inner layers may be provided with the continuous fibers 10 and/or 11 incorporated therein.

The fibers 10 and/or 11 are oriented along paths defined by the directions of the loads or in any case in the directions provided in the design phase.

In this way, the fibers 10 and/or 11 are only arranged in the portions of the item where their presence is necessary; thus, both the weight of the item and the costs are reduced since, as stated above, the use of the fibers 10 and/or 11 is optimized.

FIG. 2 also shows a portion of sacrificial material 25, again deposited by the extruder 4, having the function of supporting the item 20. The sacrificial material is subsequently removed and is therefore an inexpensive material (for example soluble) which can be easily removed.

This method allows a plurality of superimposed layers to be formed in sequence, each of which can be provided with the supporting fibers 10 and/or 11, thus enabling complex geometries.

The method is also very versatile and flexible, since fibers of a different nature can be used.

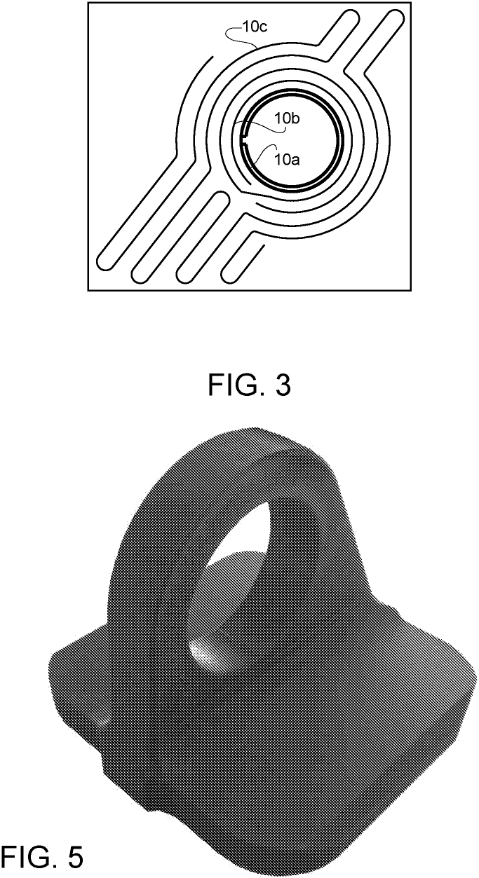

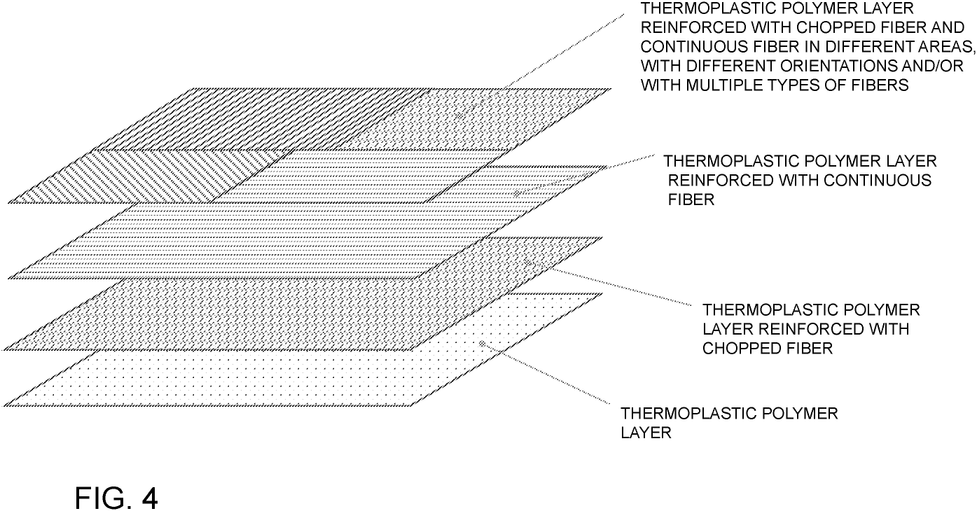

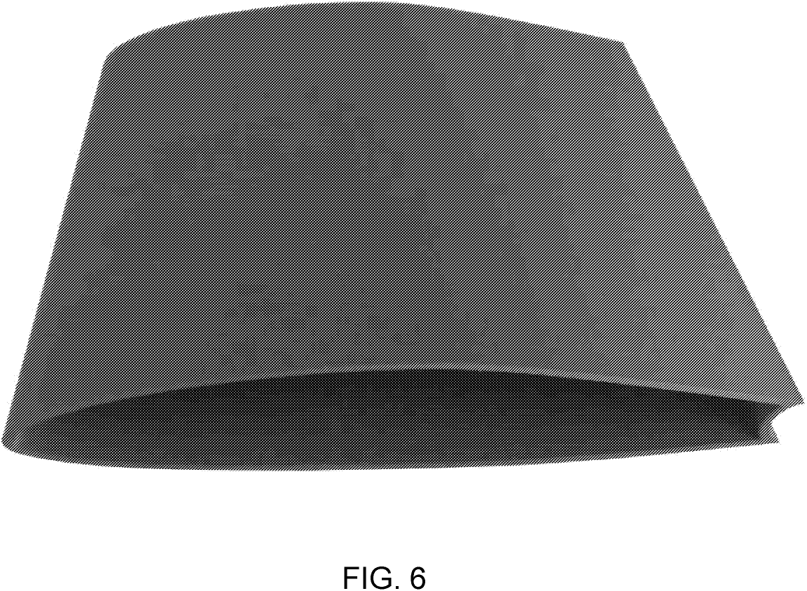

FIG. 3 shows a strategy of deposition of the continuous fiber used to produce the item 20 in a plane orthogonal to the axis of the hole 23.

As can be seen, the inner portion of the hole 23 is surrounded by a first continuous fiber 10a, which extends along a double inner circular path, and by a second continuous fiber 10b, which extends along a double outer circular path. A third continuous fiber 10c extends along a serpentine path and surrounds the first and second paths.

1. A method of realization of an aeronautical item with hybrid composite materials by means of additive technology comprising the steps of:
design of the product by means of a three-dimensional mathematical model (M(x,y,z)) which defines, in a reference system, the shape and dimensions and includes the information associated with the areas of the item that must be reinforced according to the level of stress;
deposition, by means of extruder (4) suitable for extruding a mixture (5) of polymeric material and chopped reinforcing fibers performing additive technology of a matrix according to the mathematical model;
deposition of one or more continuous fibers (10) along articulated paths in correspondence with the areas that must be reinforced according to the level of stress;
said continuous fiber (10) being soaked in the mixture (5) used for the matrix;
the method simultaneously provides for the deposition of both the mixture of polymeric material and chopped fiber and the deposition of the continuous fibers (10) after the deposition of the mixture.

2. The method according to claim 1, which comprises the step of depositing a plurality of superimposed layers to form the item, with the continuous fibers (10) arranged in one or more layers.

3. The method according to claim 2, wherein the continuous fibers (10) are oriented along paths defined by the directions of the loads or in any case in the directions provided in the design phase.

4. The method according to claim 2, wherein at least two reinforcing fibers (10) made of different materials are deposited on each layer.

5. The method according to claim 1, wherein the reinforcing fibers (10) are of the synthetic type (carbon, glass, aramid, etc.) and/or natural.

6. (canceled)
